(19) United States
(12) Patent Application Publication
(10) Pub. No.: US 2026/0138840 A1
(43) Pub. Date: May 21, 2026

(54) SYSTEM FOR MATING VAN TO LOADING DOCK

(71) Applicant: Herbert B. Fick, Minneapolis, MN (US)

(72) Inventor: Herbert B. Fick, Minneapolis, MN (US)

(21) Appl. No.: 18/949,020

(22) Filed: Nov. 15, 2024

(51) Int. Cl. B65G 69/28

(52) U.S. Cl. CPC B65G 69/2823

(57) ABSTRACT

A system includes a floor deck including a forward portion configured to support at least one pallet; a lift deck adjacent the floor deck and adapted to move vertically between a first lift deck position and a maximum height position, such that when the lift deck is in the first lift deck position, a top surface of the lift deck is substantially flush with the top surface of the floor deck; and a dock plate movably connected to the lift deck and movable between first and second dock plate positions, such that when the dock plate is in the first dock plate position, the dock plate is disposed on or in, and substantially parallel to, the lift deck, and when the dock plate is in the second dock plate position, the dock plate extends away from the lift deck opposite the forward portion.

### BACKGROUND

Loading docks have a dock height suitable for loading and unloading large box trucks or semi-tractor trailers.

### SUMMARY

Cargo vans are useful for transporting pallets and packages, are much less expensive to purchase than box trucks, and are less expensive to operate than box trucks. However, the floor of cargo vans are substantially below standard heights of loading docks. This makes it difficult to load and unload cargo vans at loading docks and typically results in manually loading and unloading by hand. However, according to some embodiments of the present description, a system that can be mounted to a floor of a cargo van provides a lift deck that can be moved at least between a level of a floor deck mounted to the floor of the van to a level suitable for mating with a standard loading dock. In order to achieve suitable mating with the loading dock, the system, according to some embodiments, includes a dock plate that is movably connected to the lift deck and that can be positioned so that the dock plate extends away from the lift deck to achieve mating with the loading dock. For example, the dock plate may be slidably connected to the lift deck so that the dock plate moves up and down with the lift deck and can be slid out from the dock plate (e.g., from a slot under a top surface of the dock plate) for mating with the loading dock when the dock plate is at a suitable height. The system may include riser brackets configured to suitably position the dock plate when it is moved out from the lift deck. The system may include a floor deck (which may also be referred to as a surround deck) that at least partially surrounds the lift deck to create a floor of approximately even height when the lift deck is in the lowered position. The floor deck can include a portion for supporting, and in some embodiments, securing for transportation, at least one pallet.

In some aspects, the present description provides a system configured to be mounted to an interior of a cargo van for mating the cargo van with a loading dock having a dock height above a floor of the cargo van. The system includes a floor deck including a forward portion configured to support at least one pallet, where the forward portion has a top surface opposite the floor and includes at least one mounting member for mounting the system to the floor of the cargo van; a lift deck adjacent the floor deck and adapted to move vertically between a first lift deck position and a maximum height position, such that when the lift deck is in the first lift deck position, a top surface of the lift deck is substantially flush with the top surface of the floor deck, and when the lift deck is in a second lift deck position above the first lift deck position and at or below the maximum height position, the top surface of the lift deck is approximately at the dock height; and a dock plate movably connected to the lift deck and movable between first and second dock plate positions, such that when the dock plate is in the first dock plate position, the dock plate is disposed on or in, and substantially parallel to, the lift deck, and when the dock plate is in the second dock plate position, the dock plate extends away from the lift deck opposite the forward portion for mating with the loading dock.

In some aspects, the present description provides a system including a floor deck that includes a first portion including at least one mounting member and having a top surface above the at least one mounting member; a lift deck adjacent the floor deck and adapted to move vertically between a first lift deck position and a maximum height position above the first lift deck position, such that when the lift deck is in the first lift deck position, a top surface of the lift deck is substantially flush with the top surface of the floor deck; and a plate slidably connected to the lift deck and movable between first and second plate positions, such that when the plate is in the first plate position, the plate is substantially parallel to the lift deck and disposed at least partially in a slot under the top surface of the lift deck, and when the plate is in the second plate position, the plate is disposed outside of the slot and extends away from the lift deck opposite the first portion.

These and other aspects will be apparent from the following detailed description. In no event, however, should this brief summary be construed to limit the claimable subject matter.

### BRIEF DESCRIPTION OF THE DRAWINGS

FIG. 1 is a schematic illustration of a system mounted to an interior of a cargo van for mating the cargo van with a loading dock, according to some embodiments.

FIGS. 2A-2B are schematic perspective views of a system, according to some embodiments.

FIG. 3 is a schematic side view of a lift system, according to some embodiments.

FIG. 4 is a schematic perspective view of a lift deck, according to some embodiments.

FIG. 5 is a schematic perspective view of the lift deck of FIG. 4 with a top plate removed, according to some embodiments.

FIG. 6 is a schematic perspective view of the lift deck of FIG. 5 with further elements removed, according to some embodiments.

FIG. 7 is a schematic side view of a rod mounted to a dock plate and engaging with a riser bracket, according to some embodiments.

FIG. 8 is a schematic perspective view of portions of a lift deck and a dock plate extending away from the lift deck, according to some embodiments.

FIG. 9 is a schematic perspective view of a riser bracket, according to some embodiments.

FIG. 10A is a schematic top view of a riser bracket with mounting portions, according to some embodiments.

FIG. 10B is a schematic perspective view of a riser bracket with mounting portions, according to some embodiments.

FIG. 11 is a schematic side view of a lift deck and lift system, according to some embodiments.

FIGS. 12A-12B are schematic end views of a lift deck and support member, according to some embodiments.

### DETAILED DESCRIPTION

In the following description, reference is made to the accompanying drawings that form a part hereof and in which various embodiments are shown by way of illustration. The drawings are not necessarily to scale. It is to be understood that other embodiments are contemplated and may be made without departing from the scope or spirit of the present description. The following detailed description, therefore, is not to be taken in a limiting sense.

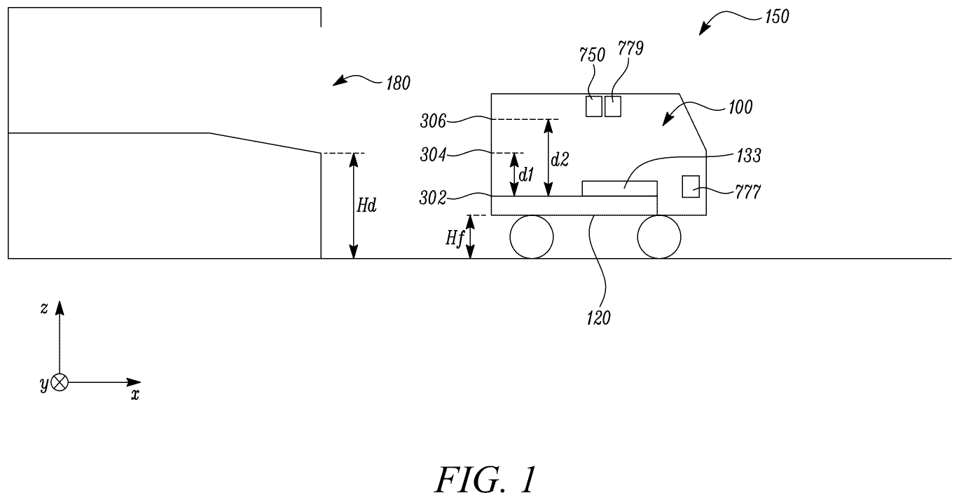

FIG. 1 is a schematic illustration of a system 100 configured to be mounted to an interior of a cargo van 150 for mating the cargo van with a loading dock 180 having a dock height Hd above (in the +z direction referring to the illustrated xyz-coordinate system) a floor 120 of the cargo van, according to some embodiments. The dock height Hd and a height Hf of the floor 120 are relative to the ground in the illustrated embodiment and “above” refers to a greater distance from the ground.

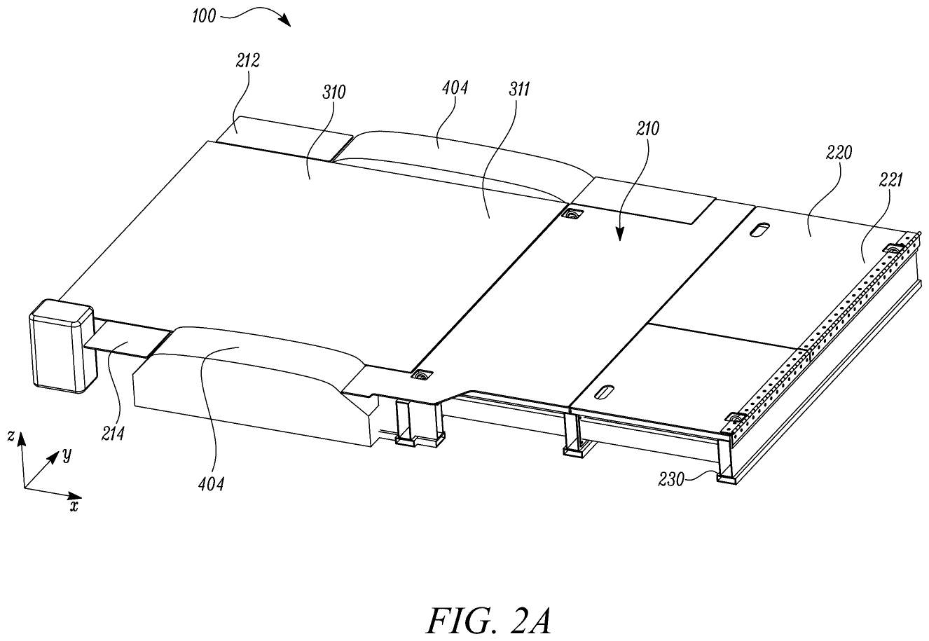

FIGS. 2A-2B are schematic perspective views of a system 100, according to some embodiments. The system 100 includes a floor deck 210 and a lift deck 310. In FIG. 2A, the floor and lift decks 210 and 310 are at approximately a same height. In FIG. 2B, the lift deck 310 is above the floor deck 210.

In some embodiments, the system 100 includes a floor deck 210 including a forward (+x direction, toward the front of the van 150) portion 220 configured to support at least one pallet 133 (see, e.g., FIG. 1), where the forward portion 220 has a top surface 221 opposite the floor 120 and may include at least one mounting member 230 for mounting the system to the floor of the cargo van. The system 100 can include a lift deck 310 adjacent to the floor deck 210 and adapted to move vertically (z-direction) between a first lift deck position 302 and a maximum height position 306, such that when the lift deck is in the first lift deck position 302, a top surface 311 of the lift deck 310 is substantially flush (e.g., at a same, or nominally same, height, or flush or nominally flush up to variations that do not significantly affect rolling a dolly, for example, across any height difference) with the top surface of the floor deck 210, and when the lift deck is in a second lift deck 304 position above the first lift deck position 302 and at or below the maximum height position 306, the top surface of the lift deck is approximately at the dock height (e.g., at, or normally at, the dock height, or sufficiently close to the dock height that the dock plate described elsewhere herein can suitably mate with the dock). In some embodiments, a van 150 includes the system 100, where the floor deck 210 is mounted to a floor 120 of the van 150.

In some embodiments, the at least one mounting member 230 is configured to space the top surface 221 of the floor deck 210 apart from the floor 120 of the cargo van 150 such that the top surface 221 of the floor deck 210 is substantially flush with the top surface 311 of the lift deck 310 when the lift deck is in the first lift deck position 302. In some embodiments, when the lift deck 310 is in the first lift deck position 302, the top surface 311 of the lift deck 310 is no more than 10, 9, 8, 7, 6.5, 6, 5.5, 5, or 4.5 inches above the floor 120 of the cargo van 150. The top surface 311 of the lift deck 310 may be at least 1, 2, 3, 3.5, or 4 inches above the floor 120 of the cargo van 150, for example.

In some embodiments, the floor deck 210 (which may also or alternatively be referred to as a surround deck) includes first and second lateral portions 212 and 214 disposed on opposite sides of the lift deck 310 such that when the lift deck 310 is in the first lift deck position 302, the top surface 311 of the lift deck 310 is substantially flush with each of the top surface of the floor deck and a top surface of each of the first and second lateral portions 212 and 214. In some embodiments, when the lift deck 310 is in the first lift deck position 302, the floor deck 210 and the lift deck 311 in combination cover substantially an entire cargo area (e.g., cover at least 80, 90, or 95 percent by area of the area behind front driver and passenger seats) of the cargo van 150 with the possible exception of wheel wells 404. In this way, substantially the entire cargo area (except wheel wells) can be at a substantially same level which is convenient for moving cargo within the cargo area and improves safety by eliminating multiple levels from which cargo could potentially fall. The system 100 may further include storage hatches built into the floor deck 210 for storing tie-downs, pallet wrap, and/or tools, for example. The system 100 may further include a plurality of tie-down locations for securing a load 133 (e.g., at least one pallet).

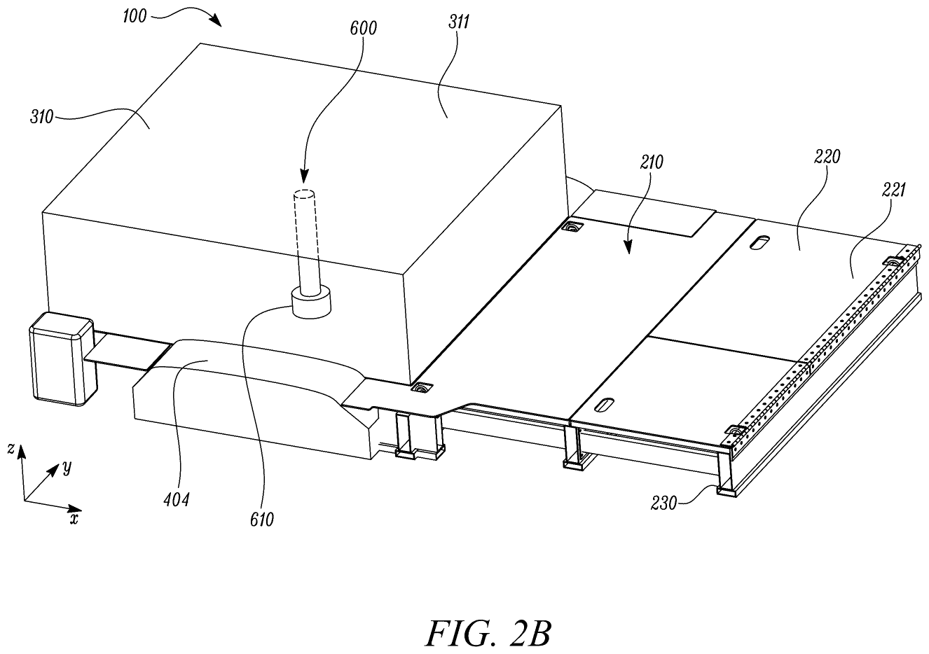

The system 100 can include a lift system 600 for moving the lift deck 310. FIG. 2B schematically illustrates a lift system 600 including an actuator 610. The lift system 600 and actuator 610 illustrated in FIG. 2B can schematically represent any suitable lift system 600 and any suitable actuator 610. For example, the lift system can include a scissor lift, an articulating lift, or air bellows, and the actuator 610 can include one or more of a hydraulic or pneumatic actuator or an electric screw drive actuator. In some embodiments, the lift system 600 can lift at least about 500, 1000, or 1500 pounds, for example. The lift system 600 may be able to lift up to about 5000, 4000, or 3000 pounds, for example. FIG. 3 is a schematic side view of a lift system 600, according to some embodiments. In some embodiments, the system 100 includes a lift system 600, where in some embodiments, the lift system 600 includes a scissor lift 611. In some embodiments, the lift system 600 includes at least one actuator 614, where the at least one actuator includes at least one of a hydraulic actuator or an electric screw drive actuator. In the embodiment of FIG. 3, the at least one actuator 614 can be or include a hydraulic actuator. In other embodiments, other lift systems and/or other actuators can be used, as would be appreciated by the person of ordinary skill in the art. In some embodiments, the lift system 600 is configured to be wired to a vehicle battery 777 of the cargo van 150 (see, e.g., FIG. 1). In some embodiments, the system 100 includes a battery 779 (e.g., different from the vehicle battery 777) connected to the lift system 600. The battery 779 may be located at any suitable location in the van 150. In some embodiments, the system 100 includes a control box 750 for controlling the position of the dock plate. The control box 750 may be located at any suitable location in the van 150. In some embodiments, the control box 750 is mounted inside the cargo van 150 (e.g., in a rear portion of the van) such the control can be lifted from its mount for use in the loading dock, for example.

In some embodiments, a vertical distance d1 (see, e.g., FIG. 1) between the first and second lift deck positions 302 and 304 is at least 6, 7, 8, 9, 10, 12, 14, 16, 18, or 20 inches. The distance d1 may be up to 40 or 35 inches, for example. In some embodiments, a vertical distance d2 (see, e.g., FIG. 1) between the first lift deck position 302 and the maximum height position 306 is at least 8, 9, 10, 12, 14, 16, 18, 20, 22, 24, 26, 28, or 30 inches. The distance d2 may be up to 50, 45 or 40 inches, for example.

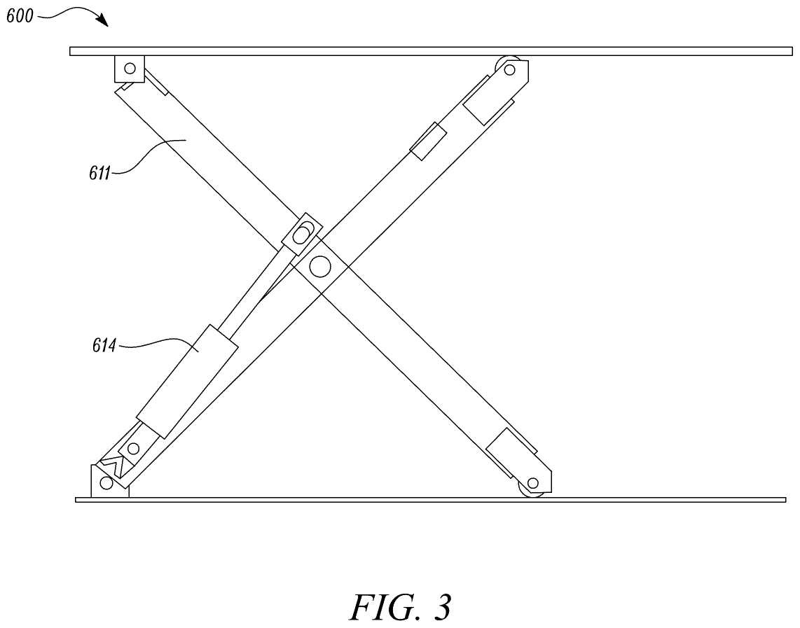

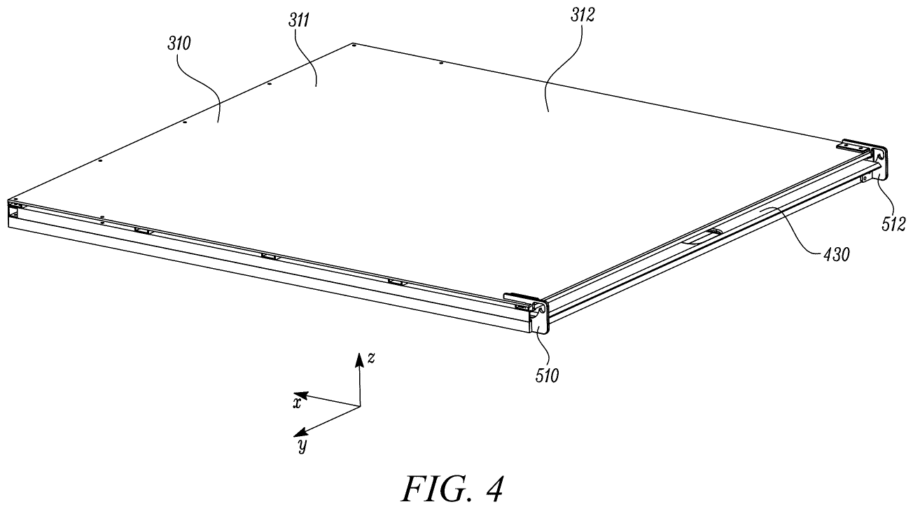

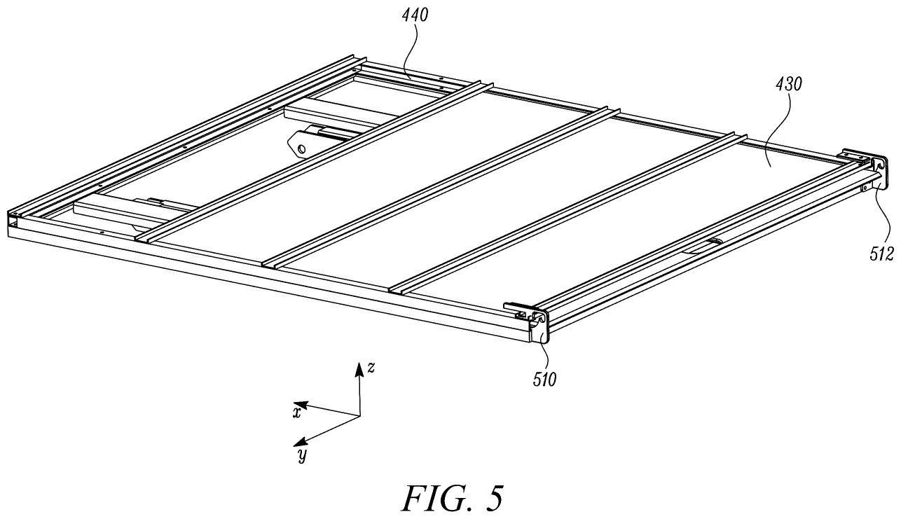

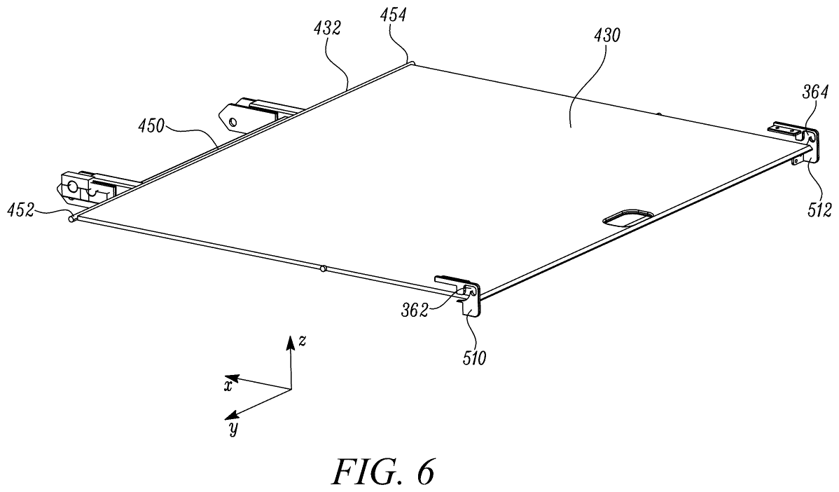

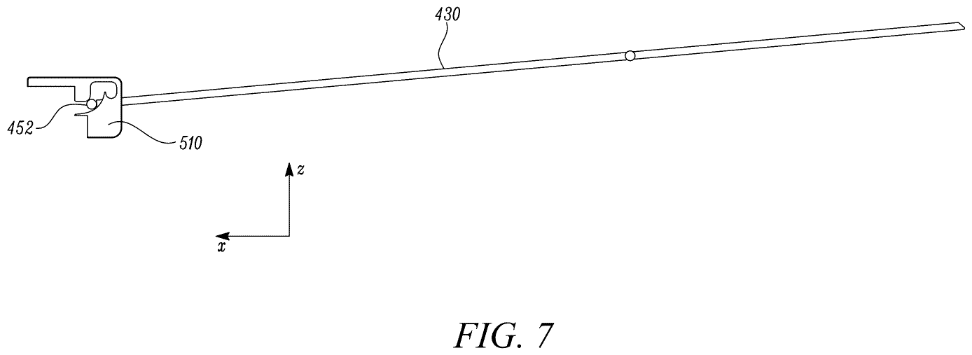

FIG. 4 is a schematic perspective view of a lift deck 310, according to some embodiments. FIG. 5 is a schematic perspective view of the lift deck 310 of FIG. 4 with a top plate 312 removed so that a substantial portion of dock plate 430 can be seen, according to some embodiments. FIG. 6 is a schematic perspective view of the lift deck 310 of FIG. 5 with further elements removed to further show dock plate 430 and riser brackets 510 and 512, according to some embodiments. FIG. 7 is a schematic side view of a rod (having end portion 452) mounted to a dock plate 430 and engaging with a riser bracket 510, according do some embodiments. FIG. 8 is a schematic perspective view of portions of a lift deck 310 and a dock plate 430 extending away from the lift deck 310, according to some embodiments.

In some embodiments, the system 100 includes a dock plate 430 movably connected to the lift deck 310 and movable between first and second dock plate positions (e.g., as schematically shown in FIGS. 4 and 8, respectively), such that when the dock plate 430 is in the first dock plate position, the dock plate 430 is disposed on or in, and substantially parallel to, the lift deck 310, and when the dock plate 430 is in the second dock plate position, the dock plate extends away from the lift deck opposite the forward portion (e.g., extends in the −x direction) for mating with the loading dock 180. In some embodiments, the dock plate 430 is slidably connected to the lift deck 310 such that when the dock plate 430 is in the first dock plate position, the dock plate is disposed at least partially in a slot 440 under the top surface 311 of the lift deck 310 and when the dock plate 430 is in the second dock plate position, the dock plate is disposed outside of the slot 440. The dock plate 430 may be slidably connected to the lift deck 310 as illustrated, or may be movably connected in other ways such as utilizing a hinge or similar attachment so that the dock plate 430 can be rotated relative to the lift deck 310.

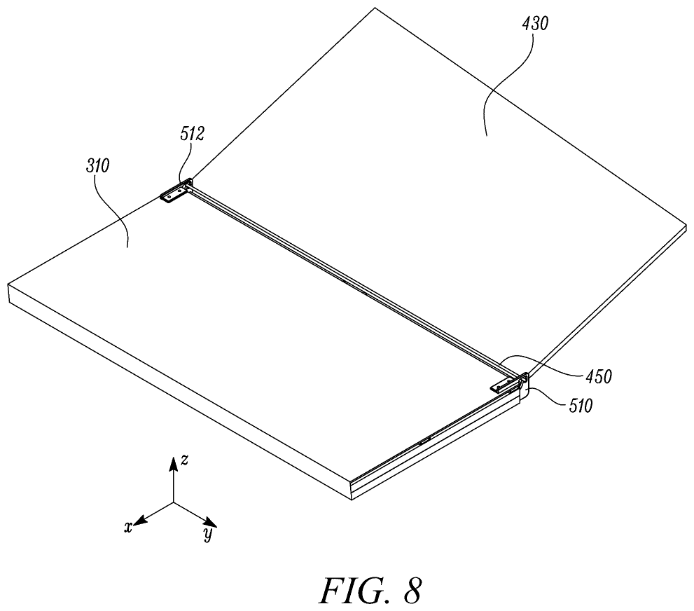

FIG. 9 is a schematic perspective view of a riser bracket that can correspond to either riser bracket 510 or 512 of FIGS. 4-6 or 8, for example, according to some embodiments. In some embodiments, the system 100 further includes a rod 450 (see, e.g., FIGS. 6 and 8) mounted to a forward (+x-direction) edge 432 of the dock plate 430, where the rod 450 includes opposite first and second end portions 452 and 454; and first and second riser brackets 510 and 512 disposed on opposite lateral sides of a rearward (−x direction) portion of the lift deck 310 and defining respective first and second slots 362 and 364 therein configured to receive the respective first and second end portions 452 and 454 of the rod 450 when the dock plate 430 is moved from the first dock plate position toward the second dock plate position. It has been found that riser brackets having suitable slot geometries position the dock plate 430 in a suitable position for mating with a loading dock, for example, when the dock plate 430 slides out from the lift deck 310.

In some embodiments, each of the first and second slots 362 and 364 includes a curved portion 521 for raising the rod 450 and a vertical portion 524 for receiving the raised rod and lowering the rod 450 so that the rod 450 rests on a curved bottom 526 of the vertical portion 524. In some embodiments, each of the first and second slots 362 and 364 includes a horizonal portion 528 extending between and connecting the curved portion 521 and the vertical portion 524. The vertical and horizontal portions 524 and 528 can extend substantially orthogonally to one another. For example, the vertical portion can extend primarily in the z-direction (more in the z-direction than in any other direction) while the horizontal portion can extend primarily in the x-direction, referring to the illustrated xyz-coordinate system. In some embodiments, the first and second end portions 452 and 454 of the rod 450 rest on the curved bottoms 526 of the vertical portions 524 of the respective first and second slots 362 and 364 when the dock plate 430 is in the second dock plate position (see, e.g., FIG. 8). In some embodiments, when the first and second end portions 452 and 454 of the rod 450 rest on the curved bottoms 526 of the vertical portions 524 of the respective first and second slots, the first and second riser brackets restrict longitudinal motion (x-direction) of the dock plate 430 (e.g., the riser brackets can be mounted to the lift deck and can restrict longitudinal motion of the dock plate relative to the lift deck due to the geometry of the slots 362, 364).

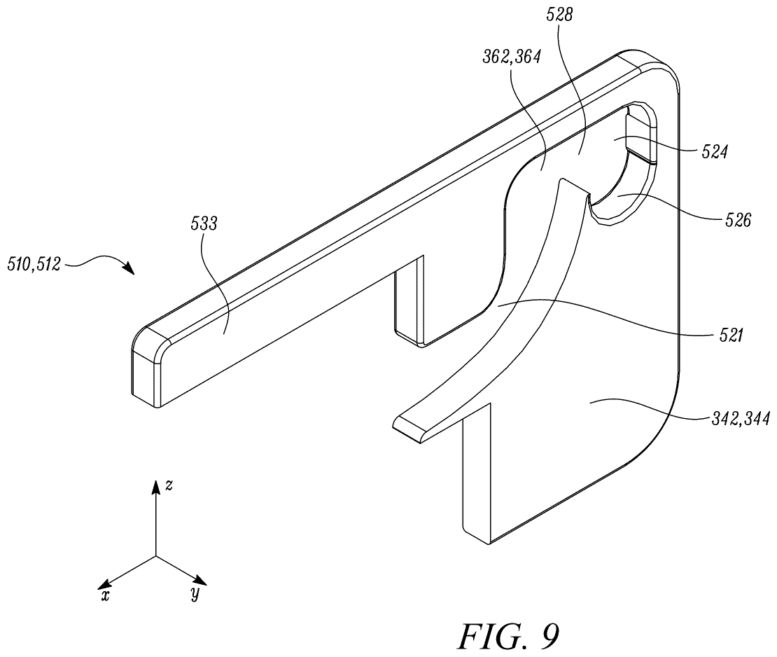

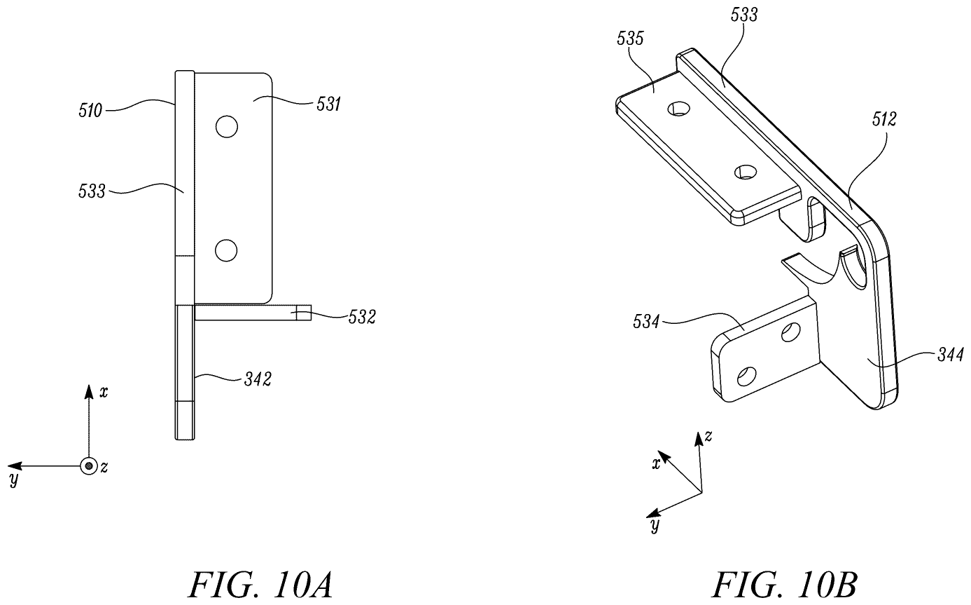

FIG. 10A is a schematic top view of a riser bracket 510, according to some embodiments. FIG. 10B is a schematic perspective view of a riser bracket 512, according to some embodiments. In some embodiments, each of the first and second riser brackets 510 and 512 includes an elongated portion 533 mounted to the lift deck 310. In some embodiments, each of the first and second riser brackets 510 and 512 further includes a mounting portion 531 and 535 attached to the elongated portion 533 for mounting the elongated portion to the lift deck 310. A mounting portion can be attached to an elongated portion by any suitable means such as adhesive bonding, bolting, or welding, for example. In some embodiments, for each of the first and second riser brackets 510 and 512, the mounting portion 531 and 535 is welded to the elongated portion 533. In some embodiments, the first and second riser brackets 510 and 512 include respective first and second flange portions 342 and 344 defining the first and second slots 362 and 364 therein. In some embodiments, each of the first and second flange portions 342 and 344 is substantially orthogonal (e.g., within 30, 20, or 10 degrees of orthogonal) to the lift deck 310. In some embodiments, the first and second riser brackets 510 and 512 include respective first and second mounting portions 532 and 534 attached to the respective first and second flange portions 342 and 344 for mounting the first and second flange portions 342 and 344 to the lift deck 310. A mounting portion can be attached to a flange portion by any suitable means such as adhesive bonding, bolting, or welding, for example. In some embodiments, the first and second mounting portions 532 and 534 are welded to the respective first and second flange portions 342 and 344.

The system 100 may be useful for mating cargo vans and loading docks, and may be useful for other applications where a deck or platform needs to be lifted for mating with another deck or platform, for example.

In some embodiments, a system 100 includes a floor deck 210 including a first portion 220 including at least one mounting member 230 and having a top surface 221 above the at least one mounting member; a lift deck 310 adjacent the floor deck and adapted to move vertically (z-direction) between a first lift deck position 302 and a maximum height position 306 above the first lift deck position, such that when the lift deck is in the first lift deck position 302, a top surface 311 of the lift deck 310 is substantially flush with the top surface of the floor deck; and a plate 430 slidably connected to the lift deck and movable between first and second plate positions, such that when the plate 430 is in the first plate position, the plate is substantially parallel to the lift deck 310 and disposed at least partially in a slot 440 under the top surface 311 of the lift deck (see, e.g., FIGS. 4-5), and when the plate 430 is in the second plate position, the plate 430 is disposed outside of the slot and extends away from the lift deck opposite the first portion 220 (see, e.g., FIG. 8). In some embodiments, the system 100 further includes a rod 450 mounted to a first edge 432 of the plate 430 and including opposite first and second end portions 452 and 454; and first and second riser brackets 510 and 512 disposed on opposite lateral sides of the lift deck 310 and defining respective first and second slots 362 and 364 therein configured to receive the respective first and second end portions 452 and 454 of the rod 450 when the plate 430 is moved from the first plate position toward the second plate position. In some embodiments, each of the first and second slots 362 and 364 includes a curved portion 521 for raising the rod 450 and a vertical portion 524 for receiving the raised rod and lowering the rod so that the rod rests on a curved bottom 526 of the vertical portion. In some embodiments, when the plate 430 is in the second plate position, the first and second end portions 452 and 454 of the rod 450 rest on the curved bottoms 526 of the vertical portions 524 of the respective first and second slots 362 and 364 and the first and second riser brackets 510 and 510 restrict longitudinal motion (x-direction) of the plate 430.

In some embodiments, a lateral width (y-direction) of the plate 430 and a lateral width of the lift deck 310 are within 20, 15, 10, or 8 percent of one another. In some embodiments, the lateral width of the plate 430 is no more than the lateral width of the lift deck 310 and is at least 80, 85, 90 or 95 percent of the lateral width of the lift deck 310. In some embodiments, a length (x-direction) of the plate 430 is greater than 50, 55, 60, or 65 percent of a length of the lift deck 310. The length of the plate 430 may be less than 100, 95, 90, or 85% of the length of the lift deck 310. In some embodiments, when the plate 430 is in the first plate position, at least 80, 85, 90, 95, 96, 97, or 98 percent of a width (y-direction) of the plate 430 and at least 80, 85, 90, 95, 96, 97, or 98 percent of a width of the lift deck 310 are coextensive with one another, and at least 40, 50, 60, 70, 75, or 80 percent of a length (x-direction) of the plate 430 and at least 40, 50, 60, 70, 75, or 80 percent of a length of the lift deck 310 are coextensive with one another (see, e.g., FIGS. 4-5). Here, the lengths and widths are along orthogonal directions with the length direction generally along a direction between the first and second plate positions and with the width direction generally between the opposite lateral sides of the lift deck 310.

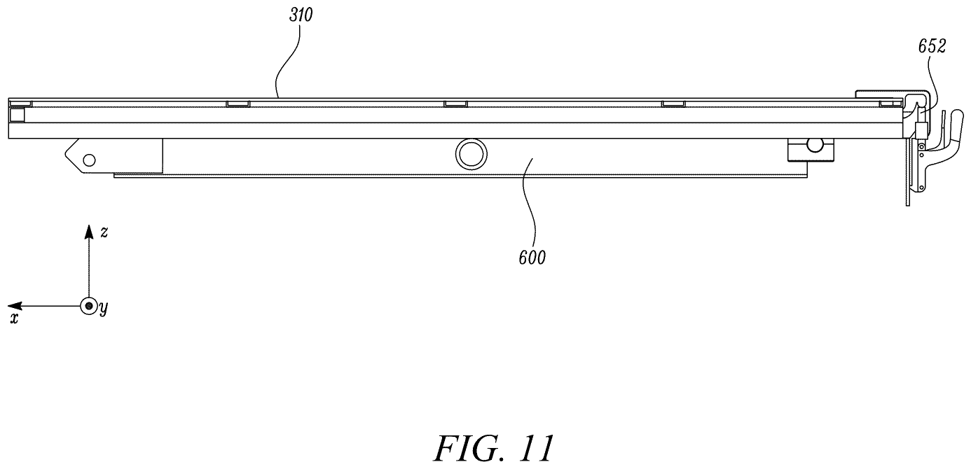

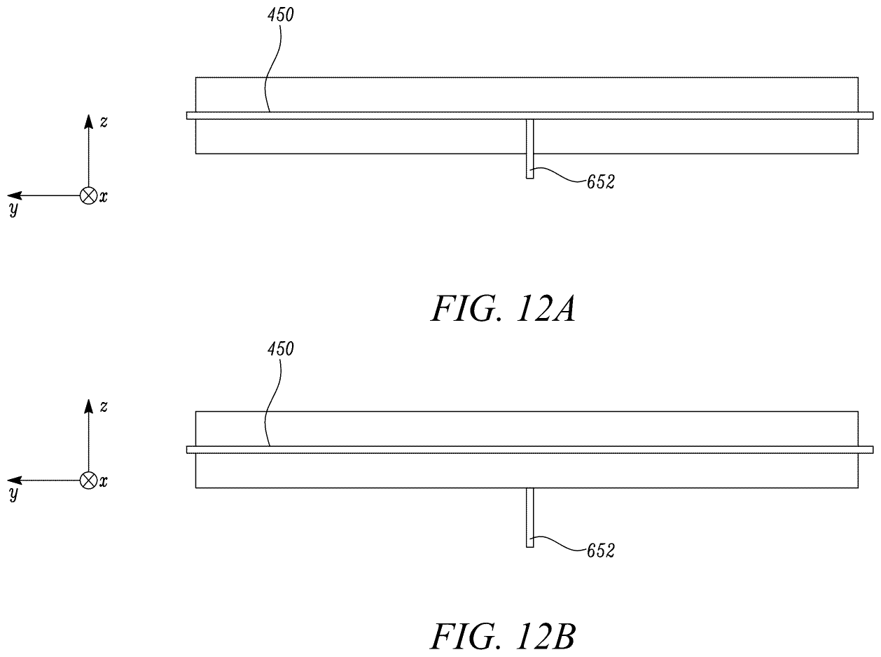

In some embodiments, the system 100 includes a mechanism (e.g., support member 652 illustrated in FIG. 11) for supporting the rod 450 when the dock plate 430 is in the second position (see, e.g., FIG. 8). It has been found, according to some embodiments, that such a support mechanism allows heavy pallet(s), for example, to be transported across the dock plate 430 without large deflections of the rod 450. FIG. 11 is a schematic side view of lift deck 310 and lift system 600 illustrating a movable support member 652 for supporting the rod 450, according to some embodiments. In FIG. 11, a portion of a riser bracket has been removed so that the support member 652 is visible. FIG. 12A is a schematic end view showing the support member 652 disposed to support the rod 450, according to some embodiments. FIG. 12B is a schematic end view showing the support member 652 moved down so that dock plate 430 can be moved back to the first dock plate position, according to some embodiments. In some embodiments, the system 100 further includes a support member 652 disposed between the first and second riser brackets 510 and 512 and movable between first and second support positions (the first and second support positions are schematically illustrated in FIGS. 12A and 12B, respectively), such that when the dock plate 430 is in the second dock plate position and the support member is in the first support position, the support member is disposed to support the rod and when the support member is in the second support position, the support member does not impede movement of the dock plate from the second dock plate position (see, e.g., FIG. 8) to the first dock plate position (see, e.g., FIG. 4). The support member 652 can be movable by any suitable means. For example, a mechanical cam lever or an electric actuator may be used.

In some embodiments, a van 150 is provided, where the van 150 includes the system 100 and the floor deck 210 is mounted to a floor 120 of the van 150. In some embodiments, a method of mating the van 150 with a dock 180 for loading or unloading the van 150 is provided. The method includes disposing the van 150 adjacent the dock 180 with a rear of the van 150 facing the dock (see, e.g., FIG. 1); moving the lift deck vertically from the first lift deck position 302 to a desired height 304 for mating with the dock (see, e.g., FIGS. 1 and 2A-2B); and extending the dock plate from the first dock plate position to the second dock plate position for mating with the dock (see, e.g., FIG. 8).

The various components of the system 100 can be made from any suitable materials using any suitable means known in the art. For example, the various decks, plates, brackets and rods can be made from stainless steel and may be cut or machined to desired shapes using standard techniques. The surfaces of the floor deck, lift deck and/or dock plate may be textured for improved grip. For example, diamond plates may be used as would be appreciated by those of ordinary skill in the art.

Terms such as “about” will be understood in the context in which they are used and described in the present description by one of ordinary skill in the art. If the use of “about” as applied to quantities expressing feature sizes, amounts, and physical properties is not otherwise clear to one of ordinary skill in the art in the context in which it is used and described in the present description, “about” will be understood to mean within 10 percent of the specified value. A quantity given as about a specified value can be precisely the specified value. For example, if it is not otherwise clear to one of ordinary skill in the art in the context in which it is used and described in the present description, a quantity having a value of about 1, means that the quantity has a value between 0.9 and 1.1, and that the value could be 1.

Terms such as “substantially” will be understood in the context in which they are used and described in the present description by one of ordinary skill in the art. If the use of “substantially” with reference to a property or characteristic is not otherwise clear to one of ordinary skill in the art in the context in which it is used and described in the present description and when it would be clear to one of ordinary skill in the art what is meant by an opposite of that property or characteristic, the term “substantially” will be understood to mean that the property or characteristic is exhibited to a greater extent than the opposite of that property or characteristic is exhibited.

Descriptions for elements in figures should be understood to apply equally to corresponding elements in other figures, unless indicated otherwise. Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations, or variations, or combinations of the specific embodiments discussed herein. Therefore, it is intended that this disclosure be limited only by the claims and the equivalents thereof.

What is claimed is:

1. A system configured to be mounted to an interior of a cargo van for mating the cargo van with a loading dock having a dock height above a floor of the cargo van, the system comprising:
a floor deck comprising a forward portion configured to support at least one pallet, the forward portion having a top surface opposite the floor and comprising at least one mounting member for mounting the system to the floor of the cargo van;
a lift deck adjacent the floor deck and adapted to move vertically between a first lift deck position and a maximum height position, such that when the lift deck is in the first lift deck position, a top surface of the lift deck is substantially flush with the top surface of the floor deck, and when the lift deck is in a second lift deck position above the first lift deck position and at or below the maximum height position, the top surface of the lift deck is approximately at the dock height; and
a dock plate movably connected to the lift deck and movable between first and second dock plate positions, such that when the dock plate is in the first dock plate position, the dock plate is disposed on or in, and substantially parallel to, the lift deck, and when the dock plate is in the second dock plate position, the dock plate extends away from the lift deck opposite the forward portion for mating with the loading dock.

2. The system of claim 1, wherein the dock plate is slidably connected to the lift deck such that when the dock plate is in the first dock plate position, the dock plate is disposed at least partially in a slot under the top surface of the lift deck and when the dock plate is in the second dock plate position, the dock plate is disposed outside of the slot.

3. The system of claim 2, further comprising:
a rod mounted to a forward edge of the dock plate and comprising opposite first and second end portions; and
first and second riser brackets disposed on opposite lateral sides of a rearward portion of the lift deck and defining respective first and second slots therein configured to receive the respective first and second end portions of the rod when the dock plate is moved from the first dock plate position toward the second dock plate position.

4. The system of claim 3, wherein each of the first and second slots comprises a curved portion for raising the rod and a vertical portion for receiving the raised rod and lowering the rod so that the rod rests on a curved bottom of the vertical portion.

5. The system of claim 4, wherein the first and second end portions of the rod rest on the curved bottoms of the vertical portions of the respective first and second slots when the dock plate is in the second dock plate position.

6. The system of claim 5, wherein when the first and second end portions of the rod rest on the curved bottoms of the vertical portions of the respective first and second slots, the first and second riser brackets restrict longitudinal motion of the dock plate.

7. The system of claim 6 further comprising a support member disposed between the first and second riser brackets and movable between first and second support positions, such that when the dock plate is in the second dock plate position and the support member is in the first support position, the support member is disposed to support the rod and when the support member is in the second support position, the support member does not impede movement of the dock plate from the second dock plate position to the first dock plate position.

8. The system of claim 1, wherein the at least one mounting member is configured to space the top surface of the floor deck apart from the floor of the cargo van such that the top surface of the floor deck is substantially flush with the top surface of the lift deck when the lift deck is in the first lift deck position.

9. The system of claim 1, wherein the floor deck comprises first and second lateral portions disposed on opposite sides of the lift deck such that when the lift deck is in the first lift deck position, the top surface of the lift deck is substantially flush with each of the top surface of the floor deck and a top surface of each of the first and second lateral portions.

10. The system of claim 9, wherein when the lift deck is in the first lift deck position, the floor deck and the lift deck in combination cover substantially an entire cargo area of the cargo van with the possible exception of wheel wells.

11. The system of claim 1, wherein when the lift deck is in the first lift deck position, the top surface of the lift deck is no more than 10 inches above the floor of the cargo van.

12. The system of claim 1 further comprising a lift system attached to the lift deck.

13. The system of claim 1, wherein a vertical distance between the first and second lift deck positions is at least 6 inches.

14. The system of claim 1, wherein a vertical distance between the first lift deck position and the maximum height position is at least 8 inches.

15. A van comprising the system of claim 1, wherein the floor deck is mounted to a floor of the van.

16. A method of mating the van of claim 15 with a dock for loading or unloading the van, the method comprising:
disposing the van adjacent the dock with a rear of the van facing the dock;
moving the lift deck vertically from the first lift deck position to a desired height for mating with the dock; and
extending the dock plate from the first dock plate position to the second dock plate position for mating with the dock.

17. A system, comprising:
a floor deck comprising a first portion comprising at least one mounting member and having a top surface above the at least one mounting member;
a lift deck adjacent the floor deck and adapted to move vertically between a first lift deck position and a maximum height position above the first lift deck position, such that when the lift deck is in the first lift deck position, a top surface of the lift deck is substantially flush with the top surface of the floor deck; and
a plate slidably connected to the lift deck and movable between first and second plate positions, such that when the plate is in the first plate position, the plate is substantially parallel to the lift deck and disposed at least partially in a slot under the top surface of the lift deck, and when the plate is in the second plate position, the plate is disposed outside of the slot and extends away from the lift deck opposite the first portion.

18. The system of claim 17, further comprising:
a rod mounted to a first edge of the plate and comprising opposite first and second end portions; and
first and second riser brackets disposed on opposite lateral sides of the lift deck and defining respective first and second slots therein configured to receive the respective first and second end portions of the rod when the plate is moved from the first plate position toward the second plate position.

19. The system of claim 18, wherein each of the first and second slots comprises a curved portion for raising the rod and a vertical portion for receiving the raised rod and lowering the rod so that the rod rests on a curved bottom of the vertical portion.

20. The system of claim 19, wherein when the plate is in the second plate position, the first and second end portions of the rod rest on the curved bottoms of the vertical portions of the respective first and second slots and the first and second riser brackets restrict longitudinal motion of the plate.
